(19) United States
(12) Patent Application Publication
(10) Pub. No.: US 2006/0250261 A1
(43) Pub. Date: Nov. 9, 2006

(54) Wearable gas detector

(76) Inventors: Ransom Parley Henrie, Moapa, NV (US); Susan B. Henrie, Moapa, NV (US)

Correspondence Address: Galasso & Associates, LP, P. O. Box 26503, Austin, TX, 78755-0503, US

(21) Appl. No.: 11/377,563

(22) Filed: Mar. 16, 2006

Related U.S. Application Data
(63) Continuation of application No. 60/678,277, filed on May 6, 2005.

(51) Int. Cl. G08B 17/10

(52) U.S. Cl. 340/632

(57) ABSTRACT

A wearable gas detector is disclosed herein that has a band adapted to wrap around a wrist of a user and a housing coupled to the band. A battery and an indicator can be secured to the housing. The housing can also contain a gas detector that is coupled to the battery and the indicator. The gas detector can be adapted to detect the presence of at least one gas and to activate the indicator to notify the user that the at least one gas has been detected. The indicator can take many forms such as that of a vibrator, an audible alarm, a siren, a buzzer and a light source. In a specific embodiment many gases can be detected such as gases that are the result of combustion.

### PRIORITY AND RELATED APPLICATION

This Application claims priority to a previously filed provisional application entitled Vibrating/Smoke Alarm Bracelet filed on May 6, 2005 and assigned Ser. No. 60/678,277.

### FIELD OF THE DISCLOSURE

The present disclosure is generally related to gas detectors and to a wearable gas detector.

### BACKGROUND

Every year many people die in accidents involving carbon monoxide poisoning and smoke inhalation. Many of these deaths occur when an individual is in a structure, such as a house or a motel and the individual does not receive adequate notice of the impending danger. For numerous reasons, smoke detectors and carbon monoxide detectors fail to adequately notify someone of an impending danger caused by noxious gasses. Smoke detectors are typically mounted high on a wall or on a ceiling in various locations. Generally, each detector requires at least one battery and batteries often go dead without notice. Detectors are often located in hard to reach locations, out of reach without a ladder and thus when a battery goes dead individuals often do not properly maintain the detector due to the inconvenience and danger associated with such maintenance procedures. Additionally, a detector will often fail to detect poisonous gases or smoke in close proximity to the eventual victim. For example, when a fire occurs in a bedroom where the victim is sleeping, and the smoke detector is in another room of the house, the smoke detector may not activate or the victim may not hear the audible alarm. Some victims are elderly, hearing impaired or deaf and cannot sense the audible signal provided by the detector. Others can slip into a deep sleep and have problems hearing the alarm and waking up. This is further exacerbated because smoke and carbon monoxide detectors are often not located in the rooms where the individual is when the smoke or carbon monoxide appears. Even individuals with perfect hearing abilities may go unwarned of a detected danger when their bedroom door is closed and that alarm is not close enough. Generally such systems often fail to notify a victim in a timely manner. Accordingly, there is a need for an improved danger notification system for toxic gases.

### BRIEF DESCRIPTION OF THE DRAWINGS

FIG. 1 is an orthogonal view of a wearable gas detector; and

FIG. 2 is a block diagram illustrating possible components of a wearable gas detector

### DETAILED DESCRIPTION OF THE DRAWINGS

Generally, methods and arrangements for improving the performance of devices that detect and notify an individual of danger are provided herein. While specific embodiments will be described below with reference to particular circuit or operating configurations, those of skill in the art will realize that embodiments may advantageously be implemented with other configurations.

The following is a detailed description of novel embodiments depicted in the accompanying drawings. The embodiments are in such detail as to clearly communicate the subject matter. However, the amount of detail offered is not intended to limit anticipated variations of the described embodiments, but on the contrary, the claims and detailed description are to cover all modifications, equivalents, and alternatives falling within the spirit and scope of the present teachings as defined by the appended claims. The detailed descriptions below are designed to make such embodiments understandable to a person having ordinary skill in the art.

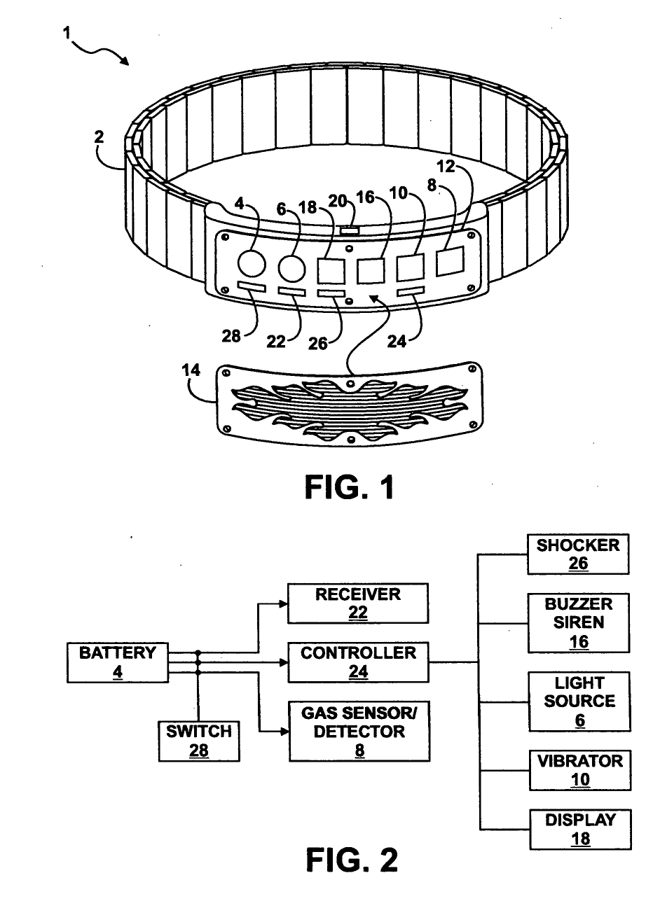

Referring to FIG. 1, a wearable gas detector 1 is provided. The wearable gas detector 1 can detect noxious gasses such as carbon monoxide and/or gases resulting from combustion, and notify a wearer of the detector 1 that a gas has been detected via numerous indicators. The wearable detector may also detect gases that contain ions, wherein the presence of the ions in the air surrounding the detector can indicate that a toxic gas is or may be present. In one embodiment, the wearable gas detector 1 vibrates, and/or provides a mild electrical pulse to the skin of the wearer to alert or awake the user. The wearable gas detector 1 is well suited to assist a hearing impaired individual.

As is illustrated, the wearable gas detector 1 can have a strap or band 2 to secure a housing 12 of the wearable gas detector 1 to an individuals arm. The band 2 can be similar to a strap that secures a watch to an individual's wrist. In other embodiments, the band 2 can be configured such that the detector can be placed around the individual's neck, bicep, chest, torso, leg, or other area of the body. Band 2 could be made of cloth, rubber, leather, or a metal material. The band 2 could be fastened to the housing 12 utilizing pins such that the band could be easily replaced. Further, the band 2 can have features that allow it to be adjusted to various diameters. In the embodiment depicted, band 2 is a “stretchy” band such as a “twist-0-flex” type band. In other embodiments, band 2 can have a clasping mechanism such as an over center latch or a buckle (not shown).

The housing 12 can secure a battery 4, a light source 6, a sensor or detector 8, a receiver 22, a display 18, a controller 24, a shocker 26, and a buzzer/siren 16. A cover 14, (shown in the removed position) can be assembled to the top of the housing 12. The cover 14 can have perforations or a screen such that any gas including air can flow into vent 20 and out of the openings in cover 14 or vise versa. Orifices, holes, vents or screens in the housing allows air or gases to flow past gas sensor 8 such that the gas sensor 8 can efficiently detected the composition of the air surrounding the bracelet.

During operation, the battery 2 can provide power to the receiver 22, the controller 24 and the gas sensor 8. The battery 2 can also provide power to the different indicators (i.e. the buzzer/siren 16, light source 6, vibrator 10, shocker 26 and display 18) when an alarm condition occurs. In one embodiment, the display 18 can be much large than shown and can be approximately the size of the cover 14. The battery 2 can be small and compact and have a disc shape such as the batteries utilized in hearing aids, watches and calculators.

Referring to FIG. 2, a block diagram of a wearable gas detector is provided. The wearable gas detector 1 can include electrical components such as a battery 4, a controller 24, a receiver 22, a gas sensor/detector 8 and indicators such as a light source 6, a display 18, a pulse generator or shocker 30, and a buzzer/siren 16, collectively referred to as indicators. The electrical components can be interconnected via circuit traces on a circuit board. In a specific embodiment, a user can select what indicator will be activated in the event of an alarm condition (i.e. when a specific gas is detected). Such a selection process can be accomplished utilizing switch 28 to proceed through a user driven menu displayed by display 18.

In operation, the gas sensor 8 can detect gas or ionized particles that result from combustion. In a specific configuration sensor 8 can detect carbon monoxide particles and other gases that are emitted when carbon-containing matter is incompletely burned. Controller 24 can receive a signal from the gas sensor 8 and selectively activate a single or multiple indicators. The indicators could be embodied as the buzzer/siren 16, the light source 6, the vibrator 10, the shocker 26, and/or the display 18. However, other types of indictors would not part from the scope of the present invention.

When activated, buzzer/siren 16 could provide a high pitched squeal or a pulsed piercing tone such as a tone utilized by cell phones, alarm clocks, wrist watches and the like. Light source 6 could provide a flashing light and could be embodied as a light emitting diode. Vibrator 10 could be an electro-mechanical transducer such as those found in pagers and cellular telephones. Shocker 26 could provide a mild electrical shock to the user such as a shock provided by a dog collar but the intensity of the shock could be user adjustable.

Display 18, could display the status of the wearable gas detector. For example the display 18 could notify the user of the battery level, what features are activated or selected, and if an alarm condition exists. In a specific embodiment, switches 28 can be utilized in cooperation with the display 18 to select specific features that can be provided by the wearable gas detector 1. For example, a user may select a combination of indicators that will be activated in the event of an alarm condition. The display 10 could be a liquid crystal display. The display 10 could display a low battery warning or the buzzer 16 could provide such a low battery warning by providing intermittent audible chirps.

In another embodiment, the receiver 22 can receive a signal from a remote detector (not shown) and when a signal is detected the receiver 22 can send a signal to the controller 24 and in turn the controller can activate an indicator. The receiver 22 could receive a simple low powered signal or be activated by a transmitter such as a radio telephone possibly by someone outside of the premise.

The above disclosed subject matter is to be considered illustrative, and not restrictive, and the appended claims are intended to cover all such modifications, enhancements, and other embodiments which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A gas detector comprising:
a wearable band adapted to wrap around a wrist of a user;
a housing coupled to the band;
a battery secured to the housing;
a gas detector secured to the housing and coupled to the battery; and
an indicator secured to the housing and coupled to the gas detector, the gas detector adapted to detect the presence of at least one gas and to activate the indicator to notify the user that the at least one gas has been detected

2. The wearable gas detector of claim 1 wherein the indicator comprises a vibrator.

3. The wearable gas detector of claim 1 wherein the indicator comprises an audible alarm.

4. The wearable gas detector of claim 4 wherein the audible alarm comprises a siren.

5. The wearable gas detector of claim 4 wherein the audible alarm comprises a buzzer.

6. The wearable gas detector of claim 1 wherein the indicator comprises a visual indicator.

7. The wearable gas detector of claim 1 wherein the indicator comprises a shocker.

8. The wearable gas detector of claim 1 wherein the band is a metal band attached to the housing with pins.

9. A gas detector comprising:
a wearable strap adapted to wrap around a portion of a body;
a housing coupled to the strap and adapted to secure a battery;
a gas detector coupled to the housing, the gas detector adapted to detect the presence of at least one gas;
an indicator coupled to the gas detector, wherein when the at least one gas is detected the indicator is activated; and
a vented cover configured to cover the housing.

10. The wearable gas detector of claim 9 wherein the indicator comprises a vibrator.

11. The wearable gas detector of claim 9 wherein the indicator comprises an audible alarm.

12. The wearable gas detector of claim 9 wherein the audible alarm comprises a siren.

13. The wearable gas detector of claim 9 wherein the audible alarm comprises a buzzer.

14. The wearable gas detector of claim 9 wherein the indicator comprises a vibrator

15. The wearable gas detector of claim 9 wherein the indicator comprises a shocker.

16. The wearable gas detector of claim 9 wherein the band is attached to the housing with pins.

17. The wearable gas detector of claim 9 further comprising a controller to control functions of the wearable gas detector.

18. A method comprising:
detecting at least one gas by a wearable gas detector; and
activating an indicator in response to detecting the at least one gas.

19. The method of claim 18 wherein activating comprises activating a vibrator.

20. The method of claim 18 wherein activating comprises activating a shocker.
